(19) United States
(12) Patent Application Publication
(10) Pub. No.: US 2014/0325755 A1
(43) Pub. Date: Nov. 6, 2014

(54) BODY LIFTING DEVICE

(71) Applicant: YANCHENG LUCKY STATIONERY CO., LTD., Sheyang (CN)

(72) Inventor: Hanzhong HE, Sheyang (CN)

(21) Appl. No.: 14/335,940

(22) Filed: Jul. 20, 2014

Related U.S. Application Data
(63) Continuation-in-part of application No. PCT/CN2013/071500, filed on Feb. 7, 2013.

(30) Foreign Application Priority Data
Feb. 11, 2012 (CN) 201220061249.X
Mar. 8, 2012 (CN) 201220121292.0
Aug. 1, 2012 (CN) 201210285055.2
Jan. 13, 2013 (CN) 201310036973.6
Feb. 4, 2013 (CN) 201310045992.5

(51) Int. Cl. A61G 7/10; A61G 7/057

(52) U.S. Cl. CPC A61G 7/1017; A61G 7/057; A61G 7/1049
USPC 5/83.1

(57) ABSTRACT

This invention relates to a body lifting device for use in combination with a bed. Conducting tubes are disposed at a side of the bed and near a patient's shoulder, hip, and knees, and is supported by the bed. Lifting rods are disposed each into one of the conducting tubes. The upper ends of the lifting rods are fixed to a lifting handle of a lifting mechanism. During use, the lifting mechanism or a fabric is placed under the patient; a driving mechanism pushes up the lifting rods to lift the patient. Thus, it's convenient for a nurse to replace bedding and take a bath for the patient. Also, it's beneficial for keeping air flowing through under the patient and avoiding bedsores. The body lifting device in combination with a bed solves a series of problems in elderly and patient care, makes elderly and patient care easier, and provides overall care for the patient.

### CROSS-REFERENCE TO RELATED APPLICATIONS

This application is a continuation-in-part of International Patent Application No. PCT/CN2013/071500 with an international filing date of Feb. 7, 2013, designating the United States, now pending, and further claims priority benefits to Chinese Patent Application No. 201220061249.X filed Feb. 11, 2012, Chinese Patent Application No. 201220121292.0 filed Mar. 8, 2012, Chinese Patent Application No. 201210285055.2 filed Aug. 1, 2012, Chinese Patent Application No. 201310036973.6 filed Jan. 13, 2013, and Chinese Patent Application No. 201310045992.5 filed Feb. 4, 2013. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

This invention relates to a nursing equipment, which is a body lifting device in combination with a bed.

2. Description of the Related Art

China has entered an aging society in which elderly and patient care becomes a heavy burden of the society. Difficulties of elderly and patient care are reflected in urination and defecation, bathing, and replacement bedding. Due to the difficulties of elderly and patient care, a patient cannot get access to proper care, recovery becomes difficult, the conditions of the patient get worse, and the patient is suffered. The cause of these difficulties lies in that elderly and patient care depends on the physical strength of a nurse and the physical strength of most nursing personnel is insufficient to lift up the patient. Furthermore, the patient cannot withstand heavy pull force and it's hard for the nurse to put forth strength.

### SUMMARY OF THE INVENTION

In view of the above-described problems, it is one objective of the invention to provide a body lifting device in combination with a bed. In this device, a mechanical auxiliary drive is used to slowly lift up the body of the patient; the nurse can replace bedding and take bath for the patient easily. It's also convenient to fetch and place a bed pan and do partial cleaning for the patient. Also, it's beneficial for keeping air flowing through under the body of the patient and avoiding bedsores.

In accordance with one embodiment of the invention, there is provided a body lifting device in combination with a bed, which comprises a lifting mechanism disposed on a bed, conducting tubes disposed at a side of the bed and near to the patient's shoulder, hip, and knee respectively, and a driving mechanism. A lifting rod is disposed in each conducting tube, the bottom of the lifting mechanism is connected to the upper ends of the lifting rods, the lower ends of the lifting rod are inserted each through one of the conducting tubes and are connected to an output of the driving mechanism.

There are at least two lifting mechanisms which are disposed along the breadth of the bed. Each lifting mechanism comprises a lifting board and a lifting handle. A socket is disposed under the lifting board that is under the shoulder of the patient, a head lift is inserted into the socket. The lower end of the lifting handle is connected with and matched with the upper end of the lifting rod.

The lifting mechanisms are disposed along the breadth of the bed. Each lifting mechanism comprises the lifting handle and an arc-shaped lift, a long axis disposed in the arc-shaped lift, and several latch hooks disposed at a first side of the bed that the long axis is disposed. The lower end of the lifting handle is connected with and matched with the upper end of the lifting rod. The lifting mechanism further comprises several inserting holes which are disposed at a second side of the bed opposite to the first side of the bed and are arranged along the breadth of the bed, and rigid rods inserted into the inserting holes. At least one fabric is extended across the body of the patient and the long axis, and is stretched by slippage preventing steps on top of the rigid rods and the latch hooks. The lower end of the lifting handle is connected with and matched with the upper end of the lifting rod.

The lower end of the lifting rod is connected to the output of the driving mechanism.

The lower end of the lifting handle is connected with and matched with the upper end of the lifting rod. The lifting mechanism drives the lifting rod to rise.

The driving mechanism comprises a worm gear, a worm, and a driving unit. The worm gear is engaged with the worm. An inner screw thread of the worm gear is engaged with an outer screw thread of the lifting rod. The worm is discontinuously disposed on a spinning shaft. An end of the spinning shaft is connected with the driving unit.

The driving unit comprises a driving motor. The end of the spinning shaft is connected with an output of the driving motor.

The driving unit comprises a driving shaft. The end of the spinning shaft is connected with the driving shaft.

The driving mechanism comprises a gas spring and a piston rod disposed inside a sleeve of the gas spring. The piston is connected with the lifting rod, a rigid pull rod is disposed between a bed frame and the sleeve of the gas spring, the piston rod of the gas spring and the lifting rod can be united.

The lifting mechanism comprises a cylinder body and a piston disposed in the cylinder body, the piston is connected with the lifting rod.

The lifting mechanism comprises an electromotion pole, a rigid pull rod is disposed between the bed frame and an inextensible component at the back of the electromotion pole, an extensible component at the front of the electromotion pole is connected with the lifting rod.

The lifting mechanism comprises an electromotion pole, a lever, and a rigid support rod disposed under a bed body and arranged in the perpendicular direction. Sliding grooves are set at two ends of the lever. The sliding groove at one end of the lever is connected with a front end of the lever, and the sliding groove at the other end of each lever is connected with the end of the lifting rod.

At least two lifting mechanisms are disposed at one side or two opposite sides of the bed frame and at force points for lifting the patient, for instance, positions under the patient's shoulder, hip, and knees. Conducting tubes supported by the bed body are disposed at positions near to the patients' should and knees, and are adjustable in an axial direction so that the device is suitable for patients having different heights. A lifting rod is disposed in each of the conducting tube, and is able to rise or decline along one of the conducting tubes by the push force exerted by the driving mechanism. The upper end of the lifting rod can be fixed by the lifting handle of the lifting mechanism. The lifting mechanism comprises the lifting board and the lifting handle. The lifting mechanism is able to rise or decline when the lifting rod rises or declines. During use, the lifting board of the lifting mechanism is placed under the body of the patient, the socket is disposed under the lifting board that is under the patient's shoulder, and the head lift is inserted into the socket; the upper end of the lifting rod is fixed to the lifting handle, the lifting rod is pushed by the driving mechanism so that the lifting mechanism is raised and the patient is lifted. There are many ways to match the upper end of the lifting rod with the lifting handle. Two tapers close to each other are set at an end of the lifting rod and an inner hole of the lifting handle respectively. When the lifting mechanism is raised up by the lifting rod, the lifting rod matches with the lifting handle in a short time; when the lifting mechanism is pulled down by the lifting rod, the lifting handle does not decline with the lifting rod and is separated from the lifting rod because the diameter of a hole set on the bed is smaller than that of the end of the lifting handle.

The lifting handle is either straight or bended. The bended lifting handle does not interfere with placing a bathtub onto the bed when the patient is lifted.

The driving mechanism exerting push force is a worm and gear driving mechanism, a gas spring driving mechanism, a fluid cylinder or gas cylinder driving mechanism, or an electromotion pole driving mechanism.

One embodiment of the worm and gear driving mechanism comprises a worm and gear box which is disposed at the joint of the conducting tube and the lifting rod and is supported by the bed body. The worm and gear box comprises a worm gear and a worm. The worm is discontinuously disposed on a spinning shaft. The worm gear is engaged with the worm, an inner screw thread is set on the worm gear, the inner screw thread of the worm gear is engaged with an outer screw thread of the lifting rod. Conducting tubes are disposed on top of and at bottom of the worm gear. A slipped mechanism is disposed between the inner screw thread of the worm gear and the outer screw thread of the lifting rod to prevent seizure of the two threads. To ensure that the lifting rod moves up and down through the worm gear without spinning, a groove extended in an axial direction is set on the outer surface of the lifting rod and a limiting block is set on the worm and gear box. The limiting block is disposed in the groove of the lifting rod to prevent the lifting rod from spinning. A driving unit is disposed at an end of the spinning shaft. The driving unit is a driving shaft or a driving motor, and is used to drive the spinning shaft to spin.

One embodiment of the gas spring driving mechanism comprises a gas spring disposed under the lifting rod, a rigid pull rod disposed between the bed frame and a sleeve of the gas spring, and optionally a base disposed under the sleeve. The piston rod of the gas spring is fixed with the lifting rod and is able to push up or pull down the lifting rod. The piston rod of the gas spring and the lifting rod can be united.

One embodiment of the fluid cylinder or gas cylinder driving mechanism comprises a fluid cylinder or a gas cylinder disposed under the lifting rod, a rigid pull rod disposed between the bed frame and a cylinder body, and optionally a base disposed under the cylinder body. Hydraulic liquid or pressurized gas is conveyed into the cylinder body by external force to push the piston rod so that the lifting rod is raised up or pulled down by the piston rod. The piston rod is fixed with the lifting rod. The piston rod and the lifting rod can be united.

One embodiment of the electromotion pole driving mechanism comprises an electromotion pole disposed under the conducting tubes and the lifting rod, a rigid pull rod disposed between the bed frame and the inextensible component at the back of the electromotion pole, and optionally a base disposed under the electromotion pole. The extensible component at the front of the electromotion pole is connected to the lifting rod. The electromotion pole pushes the lifting rod to rise or decline. There is one electromotion disposed under each of the lifting rods, or all the lifting rods share one electromotion pole.

Another embodiment of the electromotion pole driving mechanism comprises an electromotion pole and a lever. The lever is pushed by the electromotion pole to raise up or pull down the lifting rod. The above driving mechanism further comprises a rigid support rod disposed under the bed body and arranged in a perpendicular direction. Sliding grooves are set on two ends of the lever. The sliding groove at one end of the lever is connected with a front end of the electromotion pole, and the sliding groove at the other end of the lever is connected with an end of a lifting rod. Optionally, one end of each lifting rod is connected to a traverse rod, and the sliding groove at the other end of the lever is connected to the traverse rod.

Another function of the body lifting device in combination with a bed is to lift a patient by a fabric.

The lifting handle fixed with the upper end of the lifting rod is disposed at the joint of the conducting tube and the lifting rod. Arc-shaped lifts are disposed on the lifting handle. A long axis is disposed in the arc-shaped lifts of which the openings are placed in a line. Several latch hooks 36 are disposed at a first side of the bed that the long axis is disposed. Several inserting holes are disposed at the second side of the bed that is opposite to the first side of the bed, and are supported by the bed body. Rigid rods are inserted each into one of the inserting holes. Slippage preventing steps are set each on top of one of the rigid rods. At least one fabric is extended across the body of the patient and the long axis, and is stretched by slippage preventing steps and the latch hooks. During use, the long axis is lifted and the fabric is stretched by raising the lifting rods. As a result, the patient is lifted by the fabric and the space between the body of the patient and the bed is empty, and bedsores do not occur. Set a hole on the fabric at a position which is above the bed pan so that it's convenient to fetch and place the bed pan and do partial cleaning for the patient.

A mechanical auxiliary drive is used by the body lifting device in combination with a bed of this invention to slowly lift the body of a patient; a nurse can easily replace bedding and take bath for the patient. It's also convenient to fetch and place a bed pan and do partial cleaning for the patient. Also, it's beneficial for keeping air flowing through under the body of the patient and avoiding bedsores. The body lifting device in combination with a bed of this invention effectively solves a series of problems in elderly and patient care, makes elderly and patient care easier, and provides overall care for the patient.

### BRIEF DESCRIPTION OF THE DRAWINGS

FIG. 1 is a space diagram of a body lifting device in combination with a bed having a lifting mechanism;

FIG. 2 is a left view of a body lifting device in combination with a bed having a lifting mechanism;

FIG. 3 is a schematic diagram of a lifting mechanism having a head lift;

FIG. 4 is a space diagram of a lifting mechanism having a head lift;

FIG. 5 is a working principle diagram of a body lifting device in combination with a bed having a lifting mechanism;

FIG. 6 is a space diagram of a body lifting device in combination with a bed having a lifting mechanism and a worn and gear driving mechanism;

FIG. 7 is a schematic diagram of a worm and gear driving mechanism;

FIG. 8 is a space diagram of a body lifting device in combination with a bed having a lifting mechanism and a electromotion pole driving mechanism;

FIG. 9 is a space diagram of a body lifting device in combination with a bed having a lifting mechanism and a electromotion pole driving mechanism comprising an electromotion pole and a lever;

FIG. 10 is a schematic diagram of a electromotion pole driving mechanism comprising an electromotion pole and a lever;

FIG. 11 is a space diagram of a body lifting device in combination with a bed having a lifting mechanism and a gas spring driving mechanism;

FIG. 12 is a space diagram of a body lifting device in combination with a bed having a lifting mechanism and a fluid cylinder or gas cylinder driving mechanism;

FIG. 13 is a space diagram of a body lifting device in combination with a bed having a fabric; and

FIG. 14 is a left view of a body lifting device in combination with a bed having a fabric.

### DETAILED DESCRIPTION OF THE EMBODIMENTS

For further illustrating the invention, embodiments detailing a body lifting device in combination with a bed are described below. It should be noted that the following examples are intended to describe and not to limit the invention.

Embodiment 1

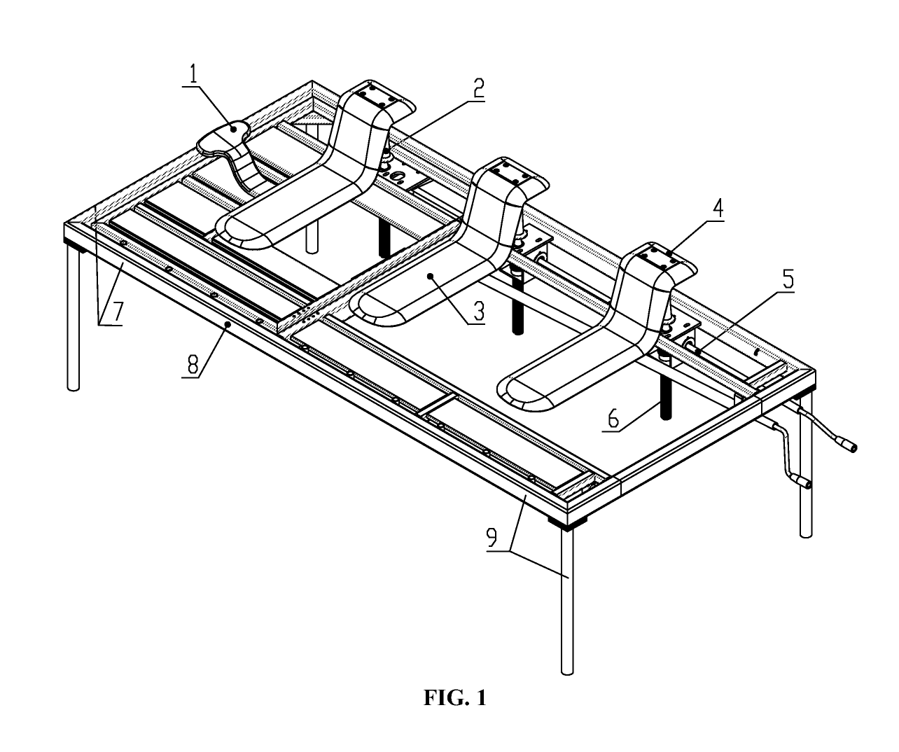

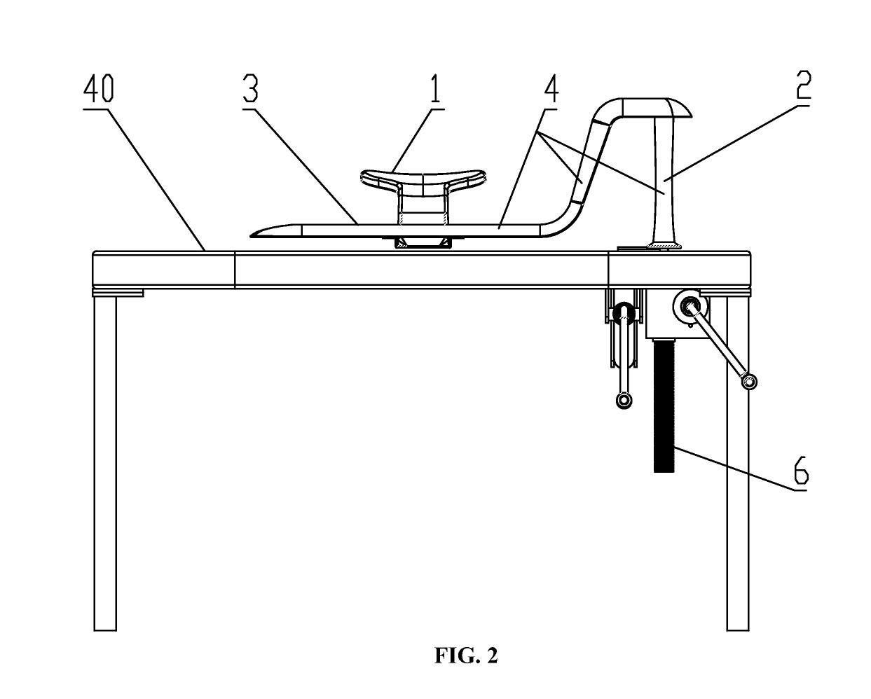

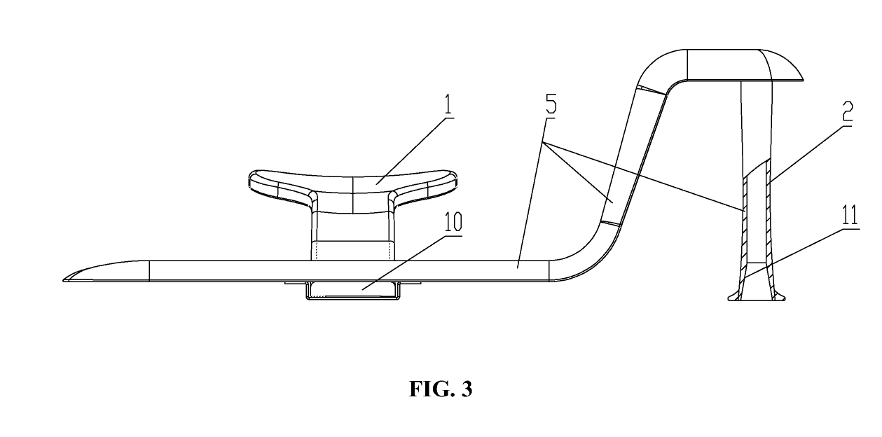

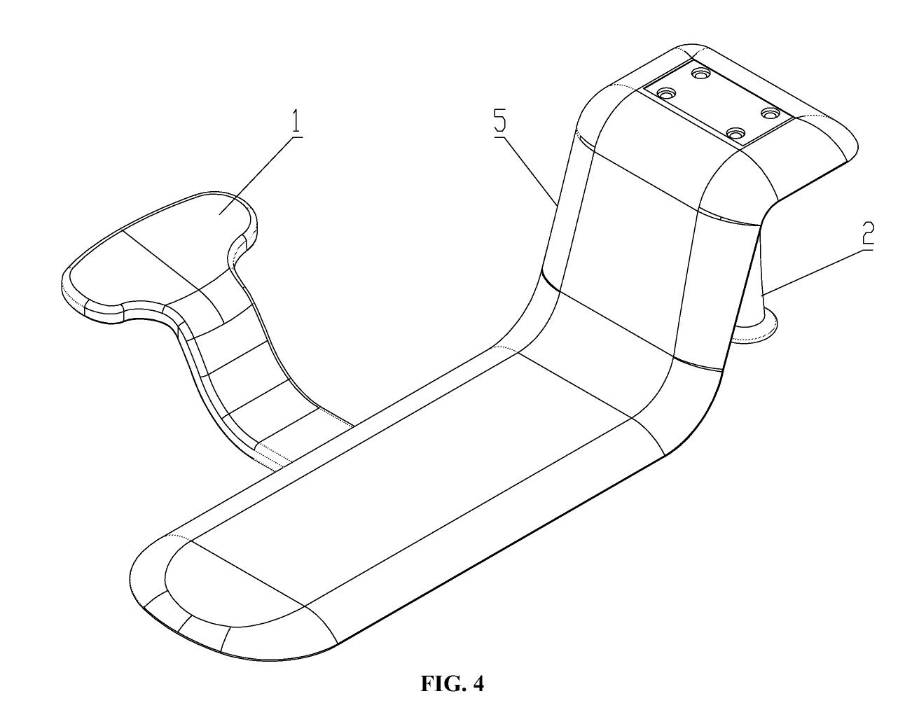

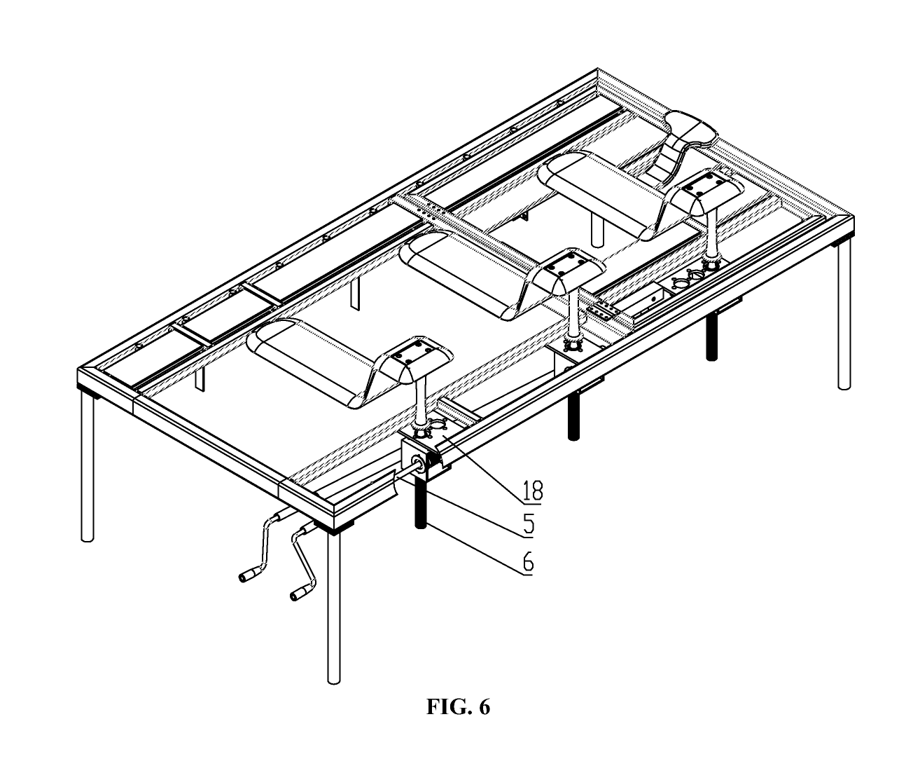

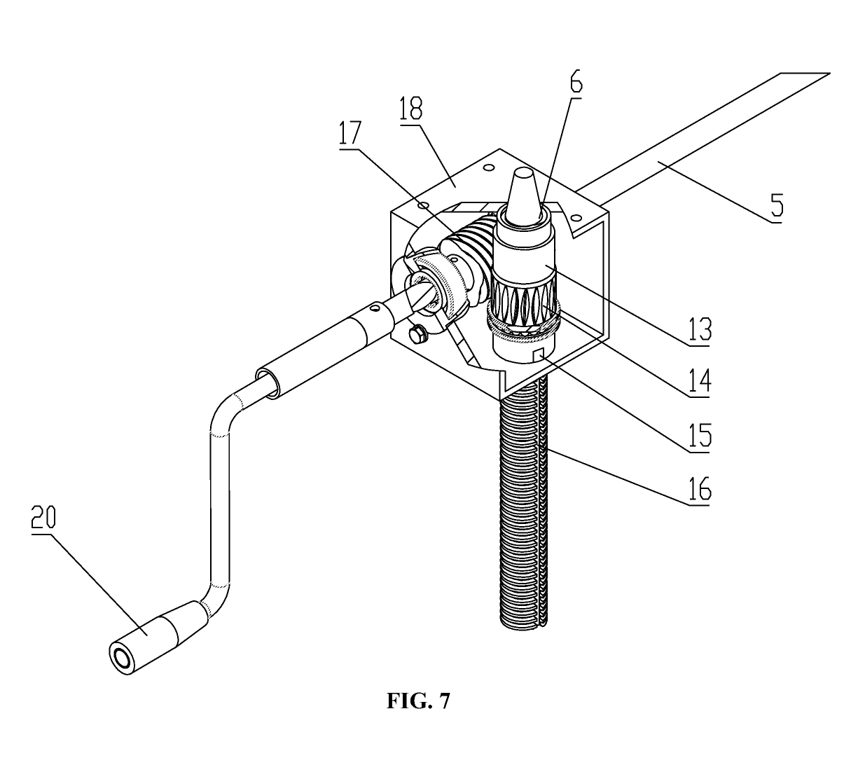

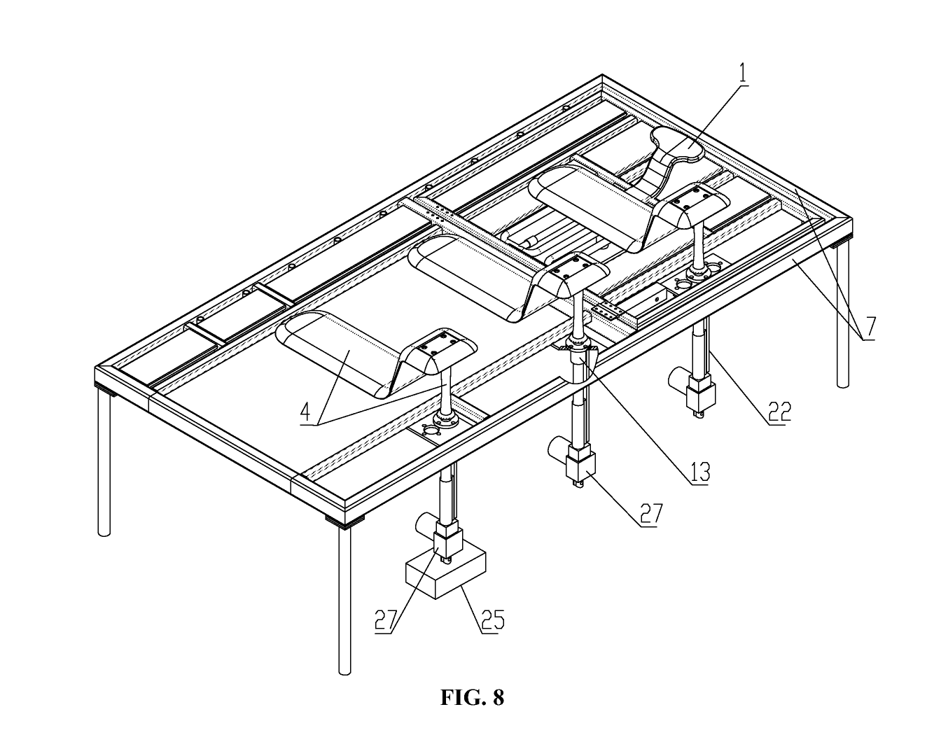

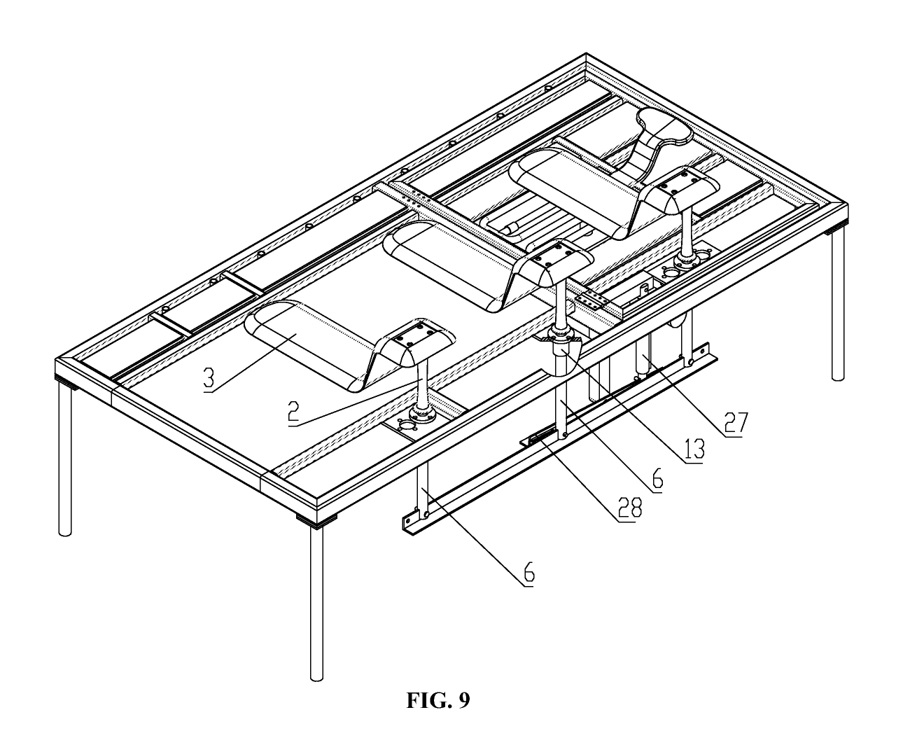

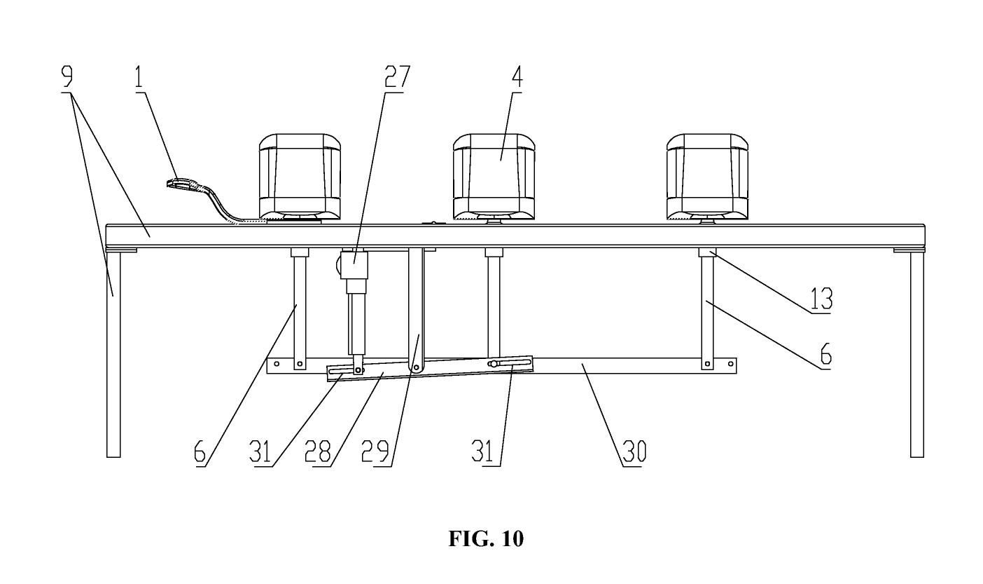

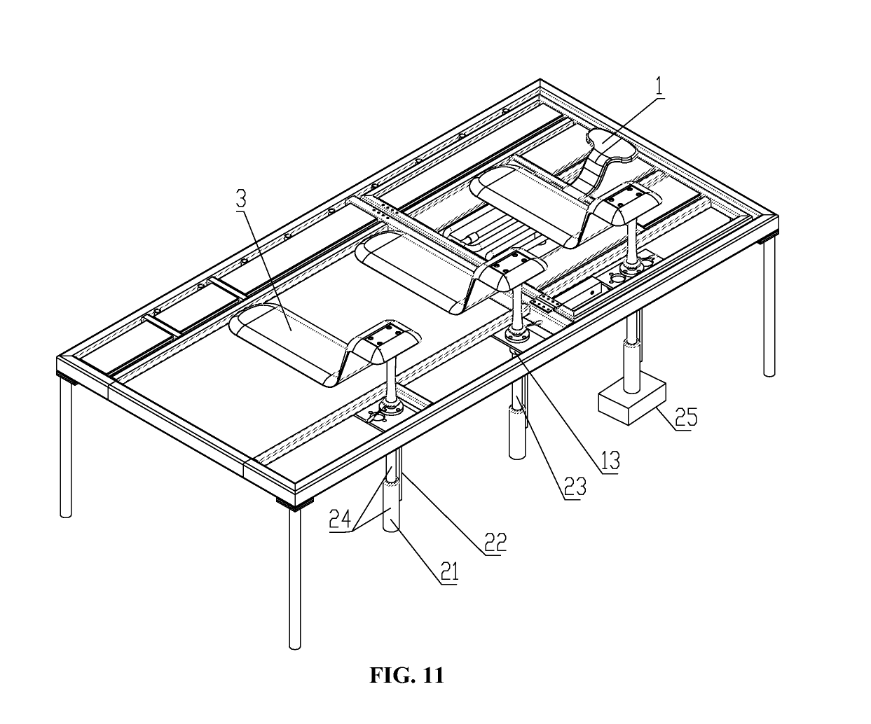

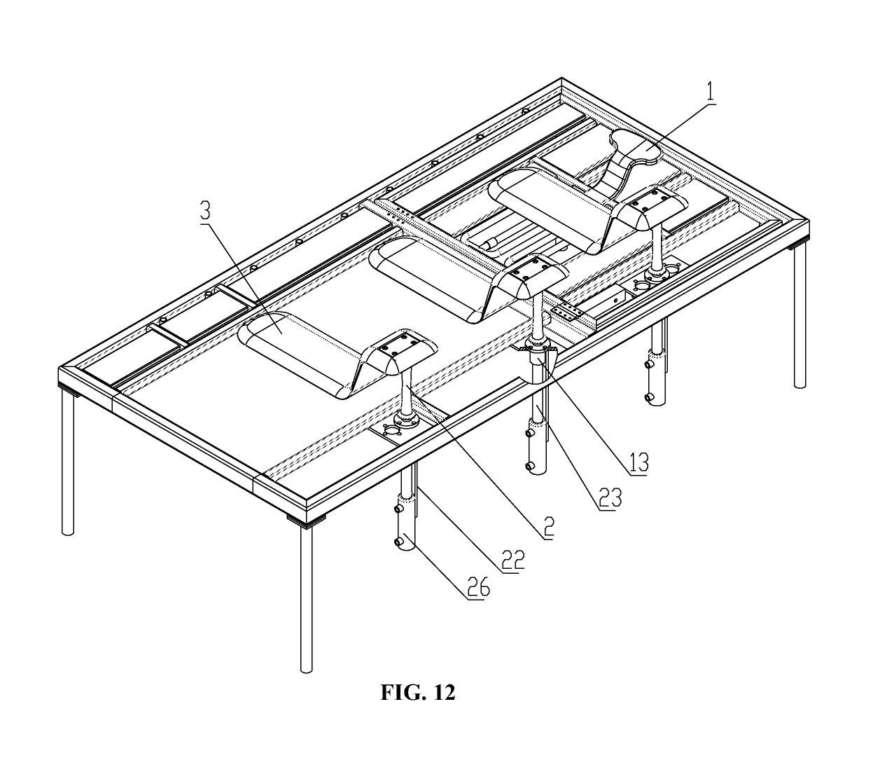

FIGS. 1-12 show an embodiment of the invention, which is a body lifting device in combination with a bed having a lifting mechanism 4.

In the body lifting device in combination with a bed having the lifting mechanism 4, conducting tubes 13 supported by the bed body 9 are disposed at one side of the breadth frame 8 of the bed frame 7 and at force points for lifting a patient, for instance, positions near to the patient's shoulder, hip, and knees. Conducting tubes 13 which is supported by the bed body 9 and near to the patient's should and knees are adjustable in the axial direction so that the device is suitable for patients having different heights. A lifting rod 6 is disposed in each of the conducting tube 13, and is able to rise or decline along an inner hole of the conducting tube 13 by the push force exerted by the driving mechanism. The upper end of the lifting rod 6 can be fixed by the lifting handle 2 of the lifting mechanism 4. The lifting mechanism 4 comprises the lifting board 3 and the lifting handle 2. The lifting mechanism 4 is able to rise or decline when the lifting rod 6 rises or declines. During use, the lifting board 3 of the lifting mechanism 4 is placed under the body of the patient, a socket 10 is disposed under the lifting board 3 which is under the patient's shoulder, and the head lift 1 is inserted into the socket 10; the upper end of the lifting rod 6 is fixed to the lifting handle 2, the lifting rod 6 is pushed by the driving mechanism so that the lifting mechanism 4 is raised and the patient is lifted.

There are many ways to fix the lifting rod 6 with the lifting handle 2. Two tapers close to each other are set at one end 19 of the lifting rod 6 and an inner hole 11 of the lifting handle 2 respectively. When the lifting mechanism 4 is raised up by the lifting rod 6, the lifting rod 6 matches with the lifting handle 2 in a short time; when the lifting mechanism 4 is pulled down by the lifting rod 6, the lifting handle 2 does not decline with the lifting rod 6 and is separated from the lifting rod 6 because the diameter of a hole set on the bed 40 is smaller than that of the end of the lifting handle 2.

The driving mechanism exerting a push force is a worm and gear driving mechanism, a gas spring driving mechanism, a fluid cylinder or gas cylinder driving mechanism, or an electromotion pole driving mechanism.

One embodiment of the worm 17 and gear 14 driving mechanism comprises a worm and gear box 18 which is disposed at the joint of the conducting tube 13 and the lifting rod 6 and is supported by the bed body 9. The worm and gear box 18 comprises a worm gear 14 and a worm 17. The worm 17 is disposed on a spinning shaft 5. The worm gear 14 is engaged with the worm 17, an inner screw thread is set on the worm gear 14, the inner screw thread of the worm gear 14 is engaged with an outer screw thread of the lifting rod 6. Conducting tubes 13 are disposed on top of and at bottom of the worm gear 14. To ensure that the lifting rod 6 moves up and down through the worm gear 14 without spinning, a groove 16 extended in an axial direction is set on the outer surface of the lifting rod 6 and a limiting block 15 is set on the worm and gear box 18. The limiting block 15 is disposed in the groove 16 of the lifting rod 6 to prevent the lifting rod 6 from spinning A driving unit 20 is disposed at the end of the spinning shaft 5. The driving unit 20 is a driving shaft or a driving motor, and is used to drive the spinning shaft 5 to spin.

One embodiment of the gas spring driving mechanism comprises a gas spring 24 disposed under the lifting rod 6, a rigid pull rod 22 disposed between the bed frame 7 and a sleeve 21 of the gas spring 24, and optionally a base 25 disposed under the sleeve 21. The piston rod 23 of the gas spring 24 is fixed with the lifting rod 6 and is able to push up or pull down the lifting rod 6. The piston rod 23 of the gas spring 24 and the lifting rod 24 can be united.

One embodiment of the fluid cylinder or gas cylinder driving mechanism comprises a fluid cylinder or a gas cylinder disposed under the lifting rod 6, a rigid pull rod 22 disposed between the bed body 9 and the cylinder body 26, and optionally a base 25 disposed under the cylinder body 26. Hydraulic liquid or pressurized gas is conveyed into the cylinder body 26 by external force to push the piston rod 23 so that the lifting rod 6 is raised up or pulled down by the piston rod 23. The piston rod 23 is fixed with the lifting rod 6. The piston rod 23 and the lifting rod 6 can be united.

One embodiment of the electromotion pole driving mechanism comprises an electromotion pole 27 disposed under the conducting tubes 13 and the lifting rod 6, a rigid pull rod 22 disposed between the bed frame 7 and the inextensible component at the back of the electromotion pole 27, and optionally a base 25 disposed under the electromotion pole 27. The extensible component at the front of the electromotion pole 27 is connected to the lifting rod 6. The electromotion pole 27 pushes the lifting rod 6 to rise or decline. There is one electromotion pole 27 disposed under each lifting rod 6, or all the lifting rods 6 share one electromotion pole 27.

Another embodiment of the electromotion pole driving mechanism comprises an electromotion pole 27 and a lever 28. The lever 28 is pushed by the electromotion pole 27 to raise up or pull down the lifting rod 6. The above driving mechanism further comprises a rigid support rod 29 disposed under the bed body 9 and arranged in the perpendicular direction. Sliding grooves 31 are set on the two ends of the lever 28. The sliding groove 31 at one end of the lever 28 is connected with a front end of the electromotion pole 27, and the sliding groove 31 at the other end of the lever 28 is connected with an end of one lifting rod 6. Optionally, one end of each lifting rod 6 is connected to a traverse rod 30, and the sliding groove at the other end of the lever 28 is connected to the traverse rod 30.

### Embodiment 2

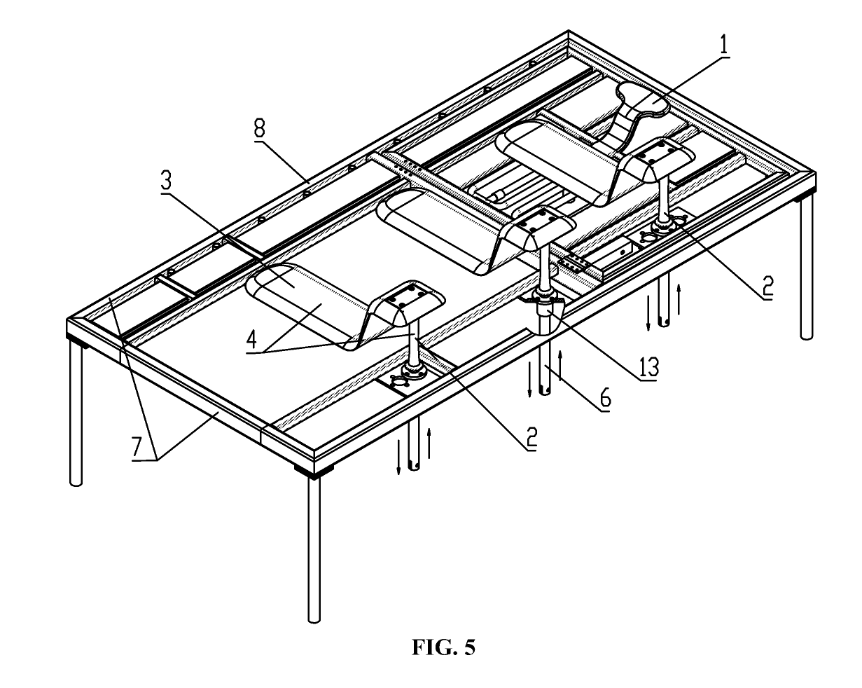

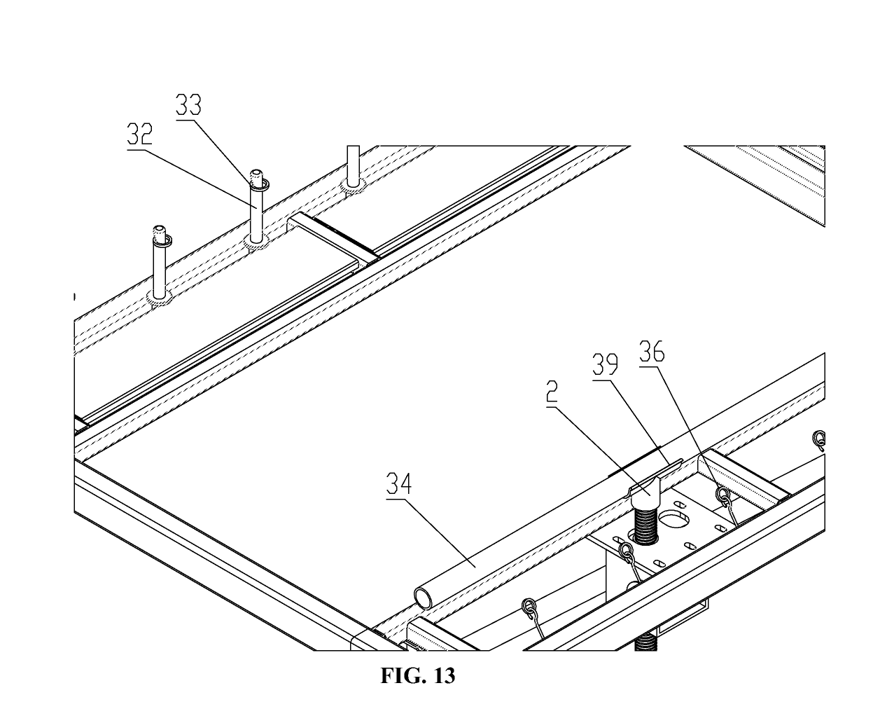

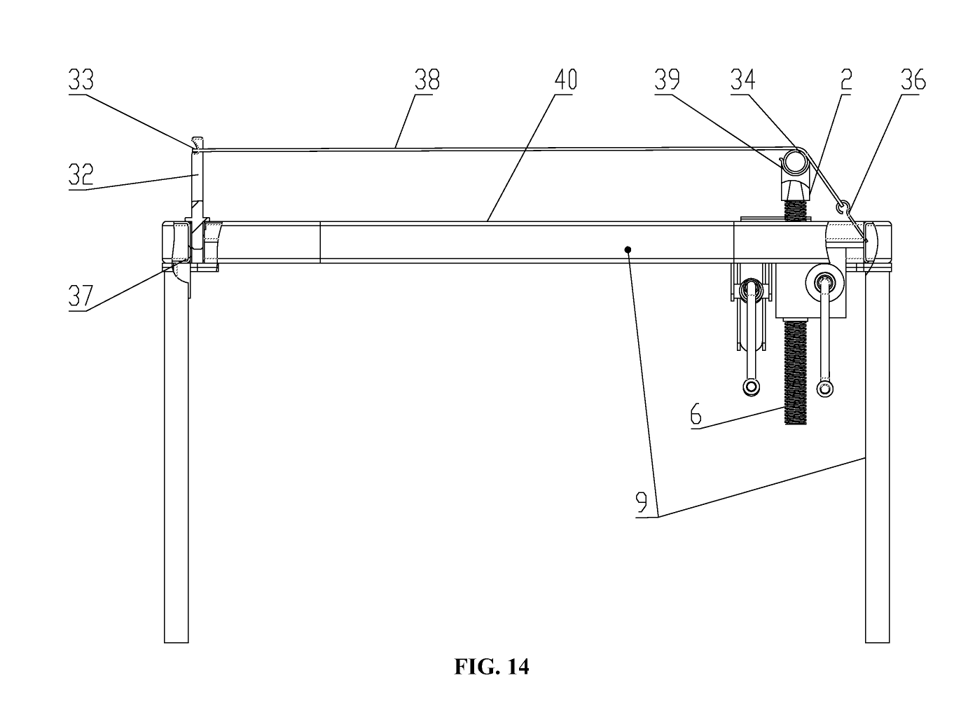

FIGS. 5-14 show another embodiment of the invention, which is a body lifting device in combination with a bed using a fabric to lift a patient.

The components of Embodiment 1 are included in this embodiment except for the lifting mechanism 4 which is disposed on the lifting rod 6. The driving mechanism exerting a push force is a worm and gear driving mechanism, a gas spring driving mechanism, a fluid cylinder or gas cylinder driving mechanism, or an electromotion pole driving mechanism. The lifting handle 2 is fixed at the upper end of the lifting rod 6. Arc-shaped lifts 39 are disposed on the lifting handle 2. A long axis 34 is disposed in the arc-shaped lifts 39 of which the openings are placed in a line. Several latch hooks 36 are disposed at a first side of the bed 40 that the long axis 34 is disposed. Several inserting holes 37 are disposed at the second side of the bed 40 that is opposite to the first side of the bed 40, and are supported by the bed body 9. Rigid rods 32 are inserted each into one of the inserting holes 37. Slippage preventing steps 33 are set each on top of one of the rigid rods 32. At least one fabric 38 is extended across the body of the patient and the long axis, and is stretched by the slippage preventing steps 33 and the latch hooks 36. During use, the long axis 34 is lifted and the fabric 38 is stretched by raising the lifting rods 6. As a result, the patient is lifted by the fabric 38 and the space between the body of the patient and the bed 40 is empty, and bedsores do not occur. Set a hole on the fabric at a position which is above the bed pan so that it's convenient to fetch and place the bed pan and do partial cleaning for the patient. The fabric 38 in this invention can be replaced by a material which is soft and is able to sustain the weight of the patient, such as leather, rope, and non-woven fabric.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A body lifting device in combination with a bed, wherein the device comprises a lifting mechanism disposed on the bed, conducting tubes disposed at a side of the bed and near to the patient's shoulder, hip, and knee respectively, and a driving mechanism, a lifting rod is disposed in each conducting tube, the bottom of the lifting mechanism is connected to the upper ends of the lifting rods, and the lower ends of the lifting rod are inserted each through one of the conducting tubes and are connected to an output of the driving mechanism.

2. The body lifting device in combination with a bed of claim 1, wherein there are at least two lifting mechanisms which are disposed along the breadth of the bed, each lifting mechanism comprises a lifting board and a lifting handle, a socket is disposed under the lifting board that is under the shoulder of the patient, a head lift is inserted into the socket, and the lower end of the lifting handle is connected with and matched with the upper end of the lifting rod.

3. The body lifting device in combination with a bed of claim 1, wherein the lifting mechanisms are disposed along the breadth of the bed, each lifting mechanism comprises the lifting handle and an arc-shaped lift, a long axis disposed in the arc-shaped lift, and several latch hooks disposed at a first side of the bed that the long axis is disposed, the lifting mechanism further comprises several inserting holes which are disposed at a second side of the bed opposite to the first side of the bed and are arranged along the breadth of the bed, and rigid rods inserted into the inserting holes, slippage preventing steps are set each on top of one of the rigid rods, at least one fabric is extended across the body of the patient and the long axis, and is stretched by slippage preventing steps on top of the rigid rods and the latch hooks, and the lower end of the lifting handle is connected with and matched with the upper end of the lifting rod.

4. The body lifting device in combination with a bed of claim 1, wherein the driving mechanism comprises a worm gear, a worm, and a driving unit, the worm gear is engaged with the worm, an inner screw thread of the worm gear is engaged with an outer screw thread of the lifting rod, the end of the worm is connected to the driving device, a groove extended in an axial direction is set on the outer surface of the lifting rod and a limiting block is set on the worm and gear box, and the worm is discontinuously disposed on a spinning shaft, an end of the spinning shaft is connected with the driving unit.

5. The body lifting device in combination with a bed of claim 1, wherein the driving mechanism comprises a gas spring and a piston rod disposed inside a sleeve of the gas spring, a rigid pull rod is disposed between a bed frame and the sleeve of the gas spring, and the piston is connected with the lifting rod.

6. The body lifting device in combination with a bed of claim 1, wherein the lifting mechanism comprises a cylinder body and a piston disposed in the cylinder body, and the piston is connected with the lifting rod.

7. The body lifting device in combination with a bed of claim 1, wherein the lifting mechanism comprises an electromotion pole, a rigid pull rod is disposed between the bed frame and an inextensible component at the back of the electromotion pole, and an extensible component at the front of the electromotion pole is connected with the lifting rod.

8. The body lifting device in combination with a bed of claim 1, wherein the lifting mechanism comprises an electromotion pole, a lever, and a rigid support rod disposed under a bed body and arranged in the perpendicular direction, sliding grooves are set at two ends of the lever, the sliding groove at one end of the lever is connected with a front end of the lever, and the sliding groove at the other end of each lever is connected with the end of the lifting rod.

9. The body lifting device in combination with a bed of claim 1, wherein the lifting handle is straight or bended.

10. The body lifting device in combination with a bed of claim 4, wherein two tapers are set at an end of the lifting rod and an inner hole of the lifting handle respectively, and the end of the lifting rod and the inner hole of the lifting handle are engaged.
